(19) United States
(12) Patent Application Publication
(10) Pub. No.: US 2025/0369698 A1
(43) Pub. Date: Dec. 4, 2025

(54) REFRIGERANT MANIFOLD

(71) Applicant: Hanon Systems, Daejeon (KR)

(72) Inventor: Byung Joo KIM, Daejeon (KR)

(73) Assignee: Hanon Systems, Daejeon (KR)

(21) Appl. No.: 19/193,347

(22) Filed: Apr. 29, 2025

(30) Foreign Application Priority Data
May 31, 2024 (KR) 10-2024-0071261

(51) Int. Cl. F28D 9/00; B60H 1/00; B60H 1/32; F28D 1/053

(52) U.S. Cl. CPC F28D 9/0037; B60H 1/00571; B60H 1/3229; F28D 1/05366

(57) ABSTRACT

The present invention relates to a refrigerant manifold including a first housing having one surface in which a first refrigerant channel is formed, and the other surface on which a plurality of component mounting parts are formed, a middle plate stacked on one surface of the first housing and configured to cover and block the first refrigerant channel, and a second housing having one surface on which a plurality of flange mounting parts are formed, and the other surface in which a second refrigerant channel is formed, the second housing being stacked on one surface of the middle plate, in which the plurality of component mounting parts are formed in a first direction, and the flange mounting part is formed in a second direction different from the first direction.

### CROSS REFERENCE TO RELATED APPLICATION

The present application claims priority to Korean Patent Application No. 10-2024-0071261, filed on May 31, 2024, the entire contents of which are incorporated herein for all purposes by this reference.

### BACKGROUND OF THE INVENTION

### Field of the Invention

The present invention relates to a refrigerant manifold applied to a cooling module constituting a cooling system for a vehicle, and more particularly, to a refrigerant manifold configured to connect a refrigerant pipe and components such as a heat exchanger and a valve.

### Description of the Related Art

Recently, as there is gradually increasing interest in energy efficiency and problems of environmental pollution, there is a need for development of environmental-friendly vehicles that can substantially replace internal combustion engine vehicles. The environmental-friendly vehicles are typically classified into an electric vehicle which operates by using fuel cells or electricity as a power source, and a hybrid vehicle that operates by using an engine and a battery.

Unlike an air conditioning device for a general vehicle, a separate heater is not used for an electric vehicle or a hybrid vehicle among the environmental-friendly vehicles. The air conditioning system applied to the environmental-friendly vehicle typically refers to a heat pump system.

Meanwhile, the electric vehicle generates driving power by converting energy, which is generated by a chemical reaction between oxygen and hydrogen, into electrical energy. In this process, because thermal energy is generated by a chemical reaction in a fuel cell, it is essential to effectively remove generated heat to ensure performance of the fuel cell.

Further, the hybrid vehicle also generates driving power by operating an engine that uses general fuel to operate and operating a motor by using electric power supplied from the fuel cell or an electric battery. Therefore, to ensure performance of the motor, it is necessary to effectively remove heat generated from the fuel cell or battery and the motor.

Therefore, in a hybrid vehicle or an electric vehicle in the related art, a cooling system, a heat pump system, and a battery cooling system are provided. Therefore, a refrigerant manifold is used to reduce a size and weight of a cooling module and simplify layouts of pipes that connect a plurality of heat exchangers and a plurality of valves.

For example, the refrigerant manifold may have a one-layer structure formed by forging a block-shaped material and then machining components, parts on which a flange of the refrigerant pipe is to be mounted, and refrigerant flow paths, such that the one-layer structure has one body without a joined portion. However, the refrigerant manifold having the one-layer structure has a problem in that a size of a package increases because of structural and processing characteristics.

In contrast, in another example, the refrigerant manifold may have a two-layer structure in which a first housing, a middle plate, and a second housing are stacked and then joined by brazing. In comparison with the refrigerant manifold having the one-layer structure, the refrigerant manifold having the two-layer structure may freely form a shape of a refrigerant flow path and reduce a size of a package. Therefore, the refrigerant manifold needs to be manufactured to have the two-layer structure. However, in the case of the refrigerant manifold having the two-layer structure, the processing cycle time and the leak test time are increased in accordance with the directions of components and assembling parts to which the flange of the refrigerant pipe is assembled. As a result, there is a problem in that manufacturing costs are increased. Therefore, there is a need for a solution for solving the above-mentioned problem.

### DOCUMENT OF RELATED ART

KR 10-2022-0162479 A (Dec. 8, 2022) “Integrated Cooling Module”

### SUMMARY OF THE INVENTION

The present invention is proposed to solve these problems and aims to provide a refrigerant manifold capable of reducing a processing cycle time for components and a leak test time for a product by improving the arrangement of parts to which components such as a heat exchanger and a valve are coupled and parts to which a flange of a refrigerant pipe is coupled in the refrigerant manifold having a two-layer structure.

In order to achieve the above-mentioned object, the present invention provides a refrigerant manifold including: a first housing having one surface in which a first refrigerant channel is formed, and the other surface on which a plurality of component mounting parts are formed; a middle plate stacked on one surface of the first housing and configured to cover and block the first refrigerant channel; and a second housing having one surface on which a plurality of flange mounting parts are formed, and the other surface in which a second refrigerant channel is formed, the second housing being stacked on one surface of the middle plate, in which the plurality of component mounting parts and the flange mounting part are formed in different directions.

In addition, the plurality of component mounting parts may be formed in the same first direction.

In addition, the flange mounting parts are formed in the same second direction.

In addition, the first direction and the second direction may be opposite to each other.

In addition, the first direction and the second direction may be directions parallel to a direction in which the first housing, the middle plate, and the second housing are stacked.

In addition, the first direction may be a direction directed from one surface toward the other surface of the first housing, and the second direction may be a direction directed from the other surface toward one surface of the second housing.

In addition, the plurality of component mounting parts may include: a heat exchanger mounting part on which a heat exchanger is mounted; a valve mounting part on which a valve is mounted; and a sensor mounting part on which a sensor is mounted, and all the heat exchanger mounting part, the valve mounting part, and the sensor mounting part may be formed in the same direction.

In addition, a component insertion hole, into which a component is inserted, may be formed in the plurality of component mounting parts and formed in a direction parallel to a first direction.

In addition, a fastening hole, into which a fastening member or a component is inserted and fastened, may be formed in the plurality of component mounting parts and formed in a direction parallel to a first direction.

In addition, a flange insertion hole, into which a communication portion protruding from a flange is inserted, may be formed in the plurality of flange mounting parts and formed in a direction parallel to a second direction.

In addition, a flange fastening hole, into which a fastening member is inserted and fastened, may be formed in the plurality of flange mounting parts and formed in a direction parallel to a second direction.

In addition, the plurality of component mounting parts may be formed in a first direction, and the flange mounting part may be formed in a third direction intersecting the first direction.

In addition, the first direction may be a direction directed from one surface toward the other surface of the first housing, and the third direction may be a direction perpendicular to the first direction.

In addition, the plurality of flange mounting parts may be disposed at an upper side of the second housing and formed in an upward direction.

In addition, a plurality of flange mounting parts may be further formed on the other surface of the first housing, and the plurality of flange mounting parts of the first housing may be formed in the third direction.

In addition, the component insertion hole may communicate with the first refrigerant channel of the first housing.

In addition, the flange insertion hole may communicate with the second refrigerant channel of the second housing.

In addition, the heat exchanger mounting part may be provided as a plurality of heat exchanger mounting parts, and any one of the heat exchangers mounted on the plurality of heat exchanger mounting parts may include a water-cooled condenser.

In addition, some of the plurality of flange mounting parts may be formed on the first housing, and the remaining flange mounting parts may be formed on the second housing.

### BRIEF DESCRIPTION OF THE DRAWINGS

FIGS. 1 to 4 are exploded perspective views and assembled perspective views illustrating a refrigerant manifold according to a first embodiment of the present invention.

FIGS. 5 to 8 are cross-sectional views illustrating a state in which components are mounted on a heat exchanger mounting part, a valve mounting part, a sensor mounting part, and a flange mounting part in the refrigerant manifold according to the first embodiment of the present invention.

FIGS. 9 to 11 are an assembled perspective view, a front view, and an upper top plan view illustrating a refrigerant manifold according to a second embodiment of the present invention.

### DETAILED DESCRIPTION OF THE INVENTION

Hereinafter, a refrigerant manifold of the present invention configured as described above will be described in detail with reference to the accompanying drawings.

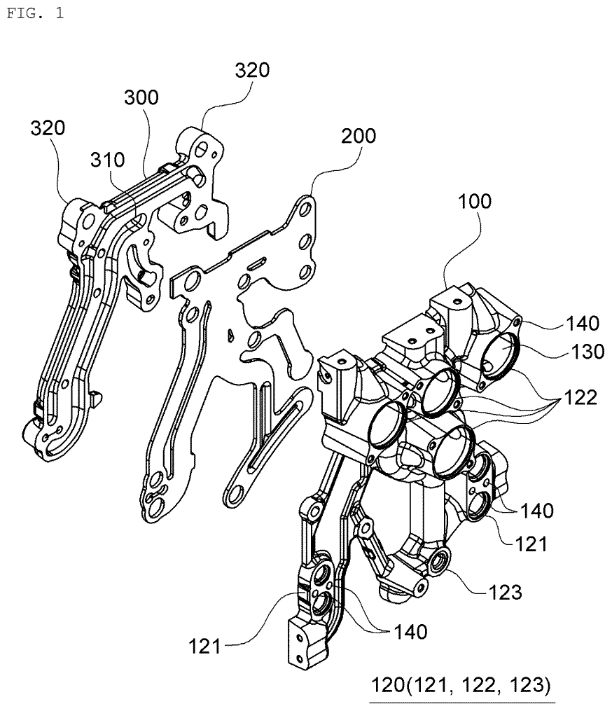

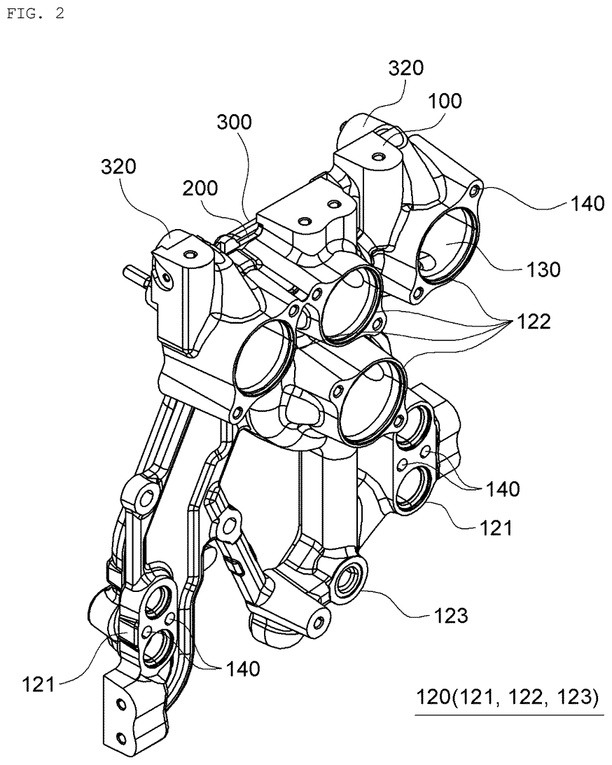

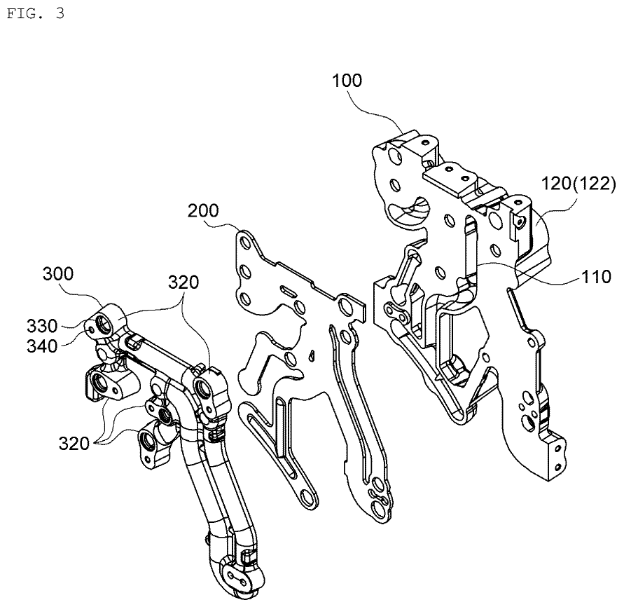

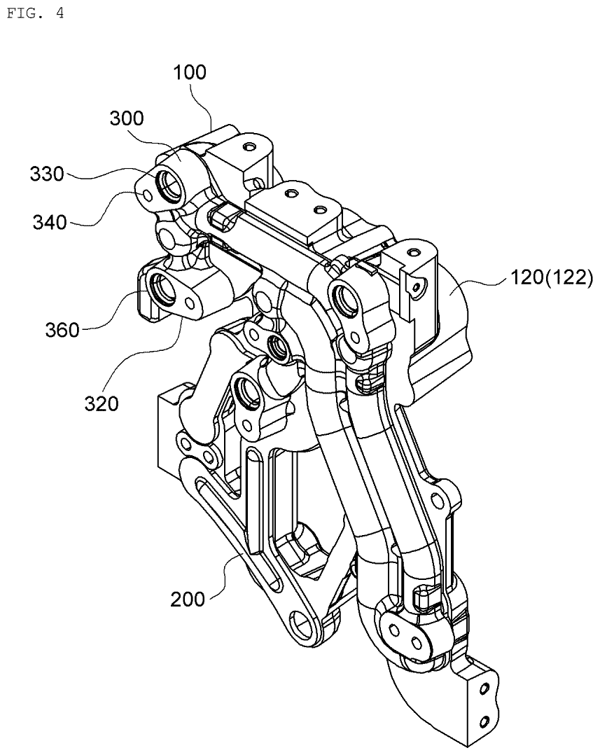

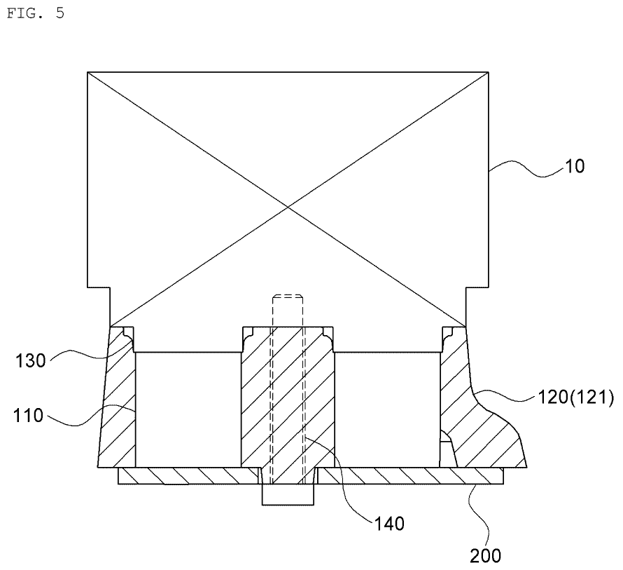

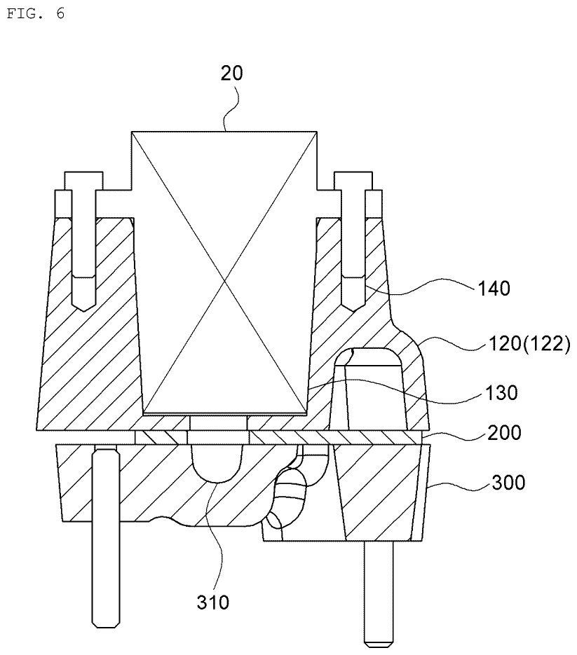

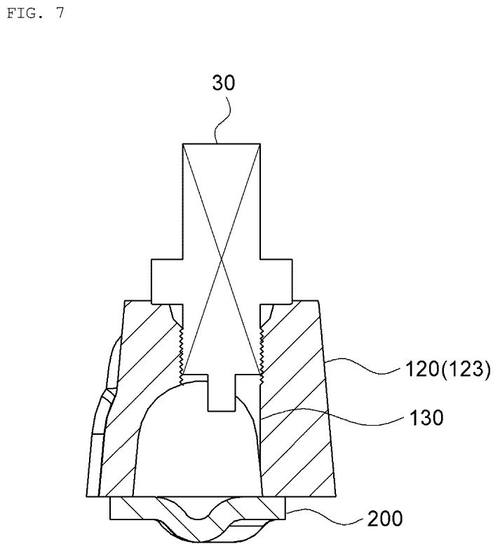

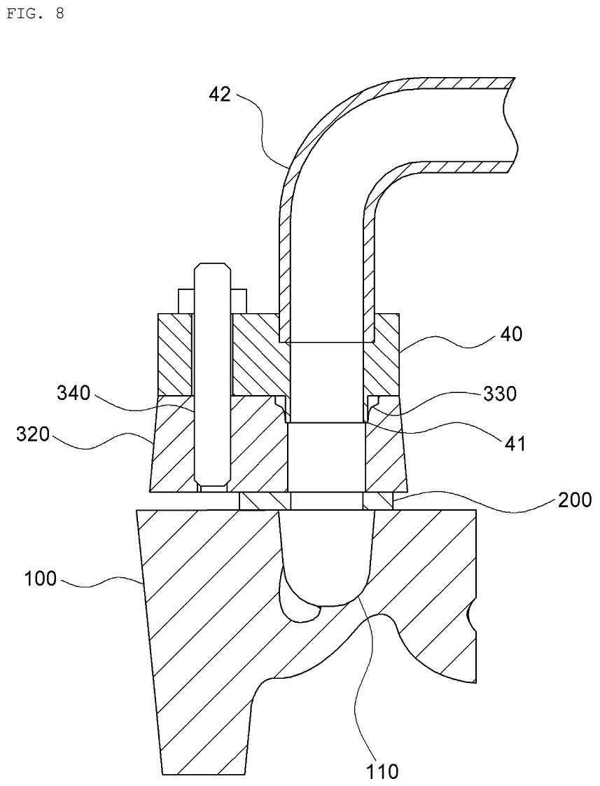

FIGS. 1 to 4 are exploded perspective views and assembled perspective views illustrating a refrigerant manifold according to a first embodiment of the present invention, and FIGS. 5 to 8 are cross-sectional views illustrating a state in which components are mounted on a heat exchanger mounting part, a valve mounting part, a sensor mounting part, and a flange mounting part in the refrigerant manifold according to the first embodiment of the present invention.

As illustrated, the refrigerant manifold according to the first embodiment of the present invention may broadly include a first housing 100, a middle plate 200, and a second housing 300.

The first housing 100 is one of the components coupled to the middle plate 200 to define a refrigerant flow path through which a refrigerant flows. A plurality of first refrigerant channels 110, through which the refrigerant flows, may be concavely formed in one surface of the first housing 100, and a plurality of component mounting parts 120, on which the components are mounted, may be formed on the other surface of the first housing 100. The components may be target components mounted on the component mounting parts 120. For example, the components may be a heat exchanger, a valve, and a sensor. In this case, the heat exchanger may be a water-cooled condenser, a chiller, or the like, the valve may be an expansion valve or a general on-off valve, and a sensor may be a PT sensor capable of measuring a pressure and temperature of the refrigerant flowing through the refrigerant flow path. In addition, the components may be various components. The component mounting part 120 may have a shape protruding from a curved surface corresponding to the first refrigerant channel 110 on the other surface of the first housing 100. The protruding end of the component mounting part 120 may be formed flat so that the protruding end may be in contact with the component. Further, the component mounting part 120 may have a component insertion hole 130 concavely formed so that a part of the component may be inserted into the component insertion hole 130. The component insertion hole 130 may communicate with the first refrigerant channel 110. The plurality of component mounting parts 120 may include a plurality of heat exchanger mounting parts 121, a plurality of valve mounting parts 122 on which the valves are mounted, and a sensor mounting part 123 on which the sensor is mounted. All the plurality of heat exchanger mounting parts 121, the plurality of valve mounting parts 122, and the sensor mounting part 123 may be formed in the same direction. For example, all the plurality of heat exchanger mounting parts 121, the plurality of valve mounting parts 122, and the sensor mounting part 123 may be formed in a direction parallel to a first direction. The first direction may be a direction directed toward the other surface from one surface. That is, the first direction may be a direction directed toward an inlet of the insertion hole 130 from the inside of the insertion hole 130 of the component mounting part 120.

The middle plate 200 may be formed in a plate shape. The middle plate 200 is one of the components coupled to the first housing 100 to define the refrigerant flow path through which the refrigerant flows. The middle plate 200 may be stacked on one surface of the first housing 100. The middle plate 200 may cover and block the first refrigerant channel 110 of the first housing 100. Further, the middle plate 200 may be provided in the form of a cladding material board having a clad layer formed on one surface or two opposite surfaces of a base material. The middle plate 200 may be joined to the first housing 100 by brazing. In addition, a hole or slit may be formed through two opposite surfaces of the middle plate 200 so that the refrigerant may pass through the hole or slit. A concave groove, in which the refrigerant may flow, may be formed in the middle plate 200.

The second housing 300 is a component coupled to the middle plate 200 to define the refrigerant flow path through which the refrigerant flows. A plurality of flange mounting parts 320 may be provided on one surface of the second housing 300, and a second refrigerant channel 310 may be concavely formed in the other surface of the second housing 300. Further, the second housing 300 may be stacked on one surface of the middle plate 200 and joined by brazing. That is, the second housing 300 is disposed at one side based on the middle plate 200, and the first housing 100 is disposed at the other side, stacked, and joined by brazing, such that the integrated refrigerant manifold may be implemented. The flange mounting part 320 is a part on which a flange 40 formed at an end of a refrigerant pipe 42 is mounted. The flange mounting part 320 may have a shape protruding from a curved surface corresponding to the second refrigerant channel 310 on one surface of the second housing 300, and the protruding end of the flange mounting part 320 may be formed flat so that the protruding end may be in contact with the flange 40. Further, a flange insertion hole 330 may communicate with the second refrigerant channel 310. In addition, all the plurality of flange mounting parts 320 may be formed in the same direction. For example, all the plurality of flange mounting parts 320 may be formed in a second direction. The second direction may be a direction directed toward one surface from the other surface. Further, the direction in which the flange insertion hole 330 is formed may be a direction parallel to the second direction. The second direction may be a direction directed toward an inlet of the flange insertion hole 330 from the inside of the flange insertion hole 330 of the flange mounting part 320. That is, the first direction and the second direction may be different directions. For example, the first direction and the second direction may be opposite to each other. In addition, the first direction and the second direction may be directions parallel to the direction in which the first housing 100, the middle plate 200, and the second housing 300 are stacked.

Therefore, because the disposition direction of the components and the disposition direction of the flange of the refrigerant pipe are opposite to each other in the refrigerant manifold of the present invention, the components and the flange of the refrigerant pipe may be easily assembled to the refrigerant manifold. Further, because the component insertion hole of the first housing and the flange insertion hole 330 of the second housing may be processed in one direction, the processing may be easily performed. In addition, all the component insertion holes 130 communicating with the first refrigerant channel 110 are directed in the first direction, and all the flange insertion holes 330 communicating with the second refrigerant channel 310 are directed in the second direction, such that the leak test may be performed on the refrigerant manifold by using two jigs after the refrigerant manifold is manufactured, and the leak test may be performed on the next components by blocking the flange insertion holes 330 by using one jig after the components are assembled to the refrigerant manifold. Therefore, the leak test for the refrigerant manifold and the components may be easily performed.

In addition, component fastening holes 140, into which fastening members or components are inserted and fastened, may be formed in the plurality of component mounting parts 120 and formed in the direction parallel to the first direction. For example, the component fastening hole 140 may be disposed adjacent to the component insertion hole 130, and the component fastening hole 140 may be formed in the direction parallel to the first direction. Therefore, a heat exchanger 10 may be easily coupled and fixed to the heat exchanger mounting part 121 by using a fastening member such as a bolt, such that a valve 20 may be easily coupled and fixed to the valve mounting part 122, and the component insertion hole 130 and the component fastening hole 140 may be easily formed. Further, an external thread may be formed on a sensor 30, and an internal thread may be formed on the component insertion hole 130 of the sensor mounting part 123, such that the sensor 30 may be coupled directly to the sensor mounting part 123 by screw-coupling.

In addition, the flange insertion hole 330 may be concavely formed in the flange mounting part 320 so that a communication portion 41 protruding from the flange 40 formed at the end of the refrigerant pipe 42 may be inserted into the flange insertion hole 330. Flange fastening holes 340 may be formed in the plurality of flange mounting parts 320 so that the fastening members may be inserted and fastened into the flange fastening holes 340. The flange fastening hole 340 may be formed in the direction parallel to the second direction. Therefore, the flange 40 may be easily coupled and fixed to the flange mounting part 320 by using the fastening members such as bolts and nuts, and the flange insertion hole 330 and the flange fastening hole 340 may be easily formed.

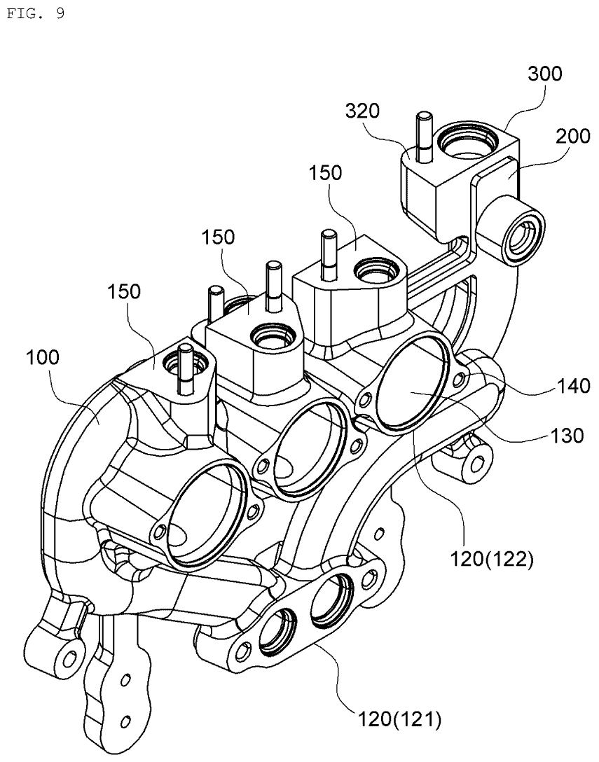

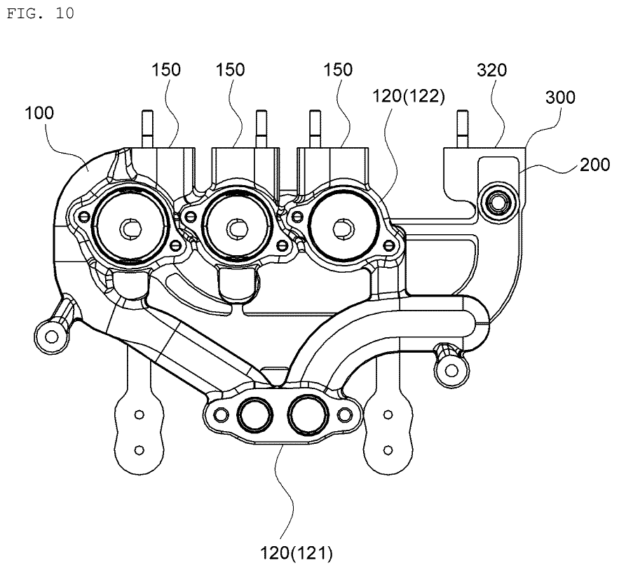

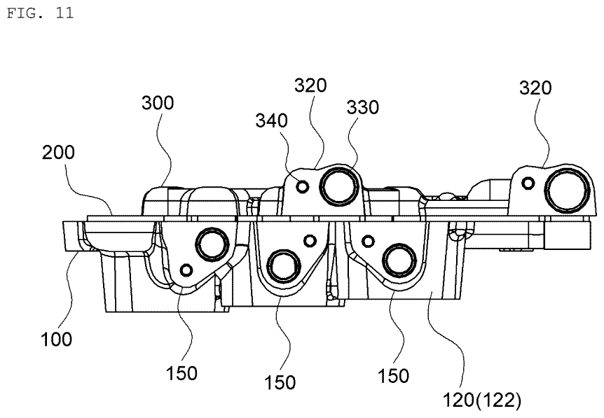

FIGS. 9 to 11 are an assembled perspective view, a front view, and an upper top plan view illustrating a refrigerant manifold according to a second embodiment of the present invention.

As illustrated, the refrigerant manifold according to the second embodiment of the present invention may differ from that in the first embodiment in terms of positions and directions in which the plurality of flange mounting parts are formed, and the second embodiment may be identical to the first embodiment in terms of the remaining configurations.

The plurality of flange mounting parts 320 may be provided on the second housing 300, and the plurality of flange mounting parts 320 may be formed in a direction intersecting the first direction. For example, the plurality of flange mounting parts 320 may be formed in a third direction perpendicular to the first direction. Further, the plurality of flange mounting parts 320 may be disposed at an upper side or an upper end of the second housing 300 and formed upward. In addition, a plurality of flange mounting parts 150 may be further provided on the first housing 100. That is, some of the plurality of flange mounting parts may be formed on the first housing 100, and the remaining flange mounting parts may be formed on the second housing 300.

Like the flange mounting part 320 of the second housing 300, the plurality of flange mounting parts 150 of the first housing 100 may be formed in the third direction, and the plurality of flange mounting parts 150 of the first housing 100 may be provided at an upper side or an upper end of the first housing 100 and formed upward.

Therefore, it is possible to improve the degree of design freedom related to the position at which the flange mounting part is formed, and it is possible to facilitate the installation and maintenance of the flange of the refrigerant pipe in the refrigerant manifold. In addition, it is possible to facilitate the leak test for the refrigerant manifold and the leak test for the components.

According to the refrigerant manifold of the present invention, the components may be processed in one direction, which may reduce the processing cycle time for the components.

Further, the leak test may be performed on the refrigerant manifold by using the two jigs after the refrigerant manifold is manufactured, and the leak test may be performed on the components by using one jig after the components are assembled to the refrigerant manifold, which may reduce the leak test time for the refrigerant manifold and the components.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: First housing
110: First refrigerant channel
120: Component mounting part
121: Heat exchanger mounting part
122: Valve mounting part
123: Sensor mounting part
130: Component insertion hole
140: Component fastening hole
150: Flange mounting part
200: Middle plate
300: Second housing
310: Second refrigerant channel
320: Flange mounting part
330: Flange insertion hole
340: Flange fastening hole
10: Heat exchanger
20: Valve
30: Sensor
40: Flange
41: Communication portion
42: Refrigerant pipe

What is claimed is:

1. A refrigerant manifold comprising:
a first housing having one surface in which a first refrigerant channel is formed, and the other surface on which a plurality of component mounting parts are formed;
a middle plate stacked on one surface of the first housing and configured to cover and block the first refrigerant channel; and
a second housing having one surface on which a plurality of flange mounting parts are formed, and the other surface in which a second refrigerant channel is formed, the second housing being stacked on one surface of the middle plate,
wherein the plurality of component mounting parts and the flange mounting part are formed in different directions.

2. The refrigerant manifold of claim 1, wherein the plurality of component mounting parts are formed in the same first direction.

3. The refrigerant manifold of claim 2, wherein the flange mounting parts are formed in the same second direction.

4. The refrigerant manifold of claim 3, the first direction and the second direction are opposite to each other.

5. The refrigerant manifold of claim 3, the first direction and the second direction are directions parallel to a direction in which the first housing, the middle plate, and the second housing are stacked.

6. The refrigerant manifold of claim 3, wherein the first direction is a direction directed from one surface toward the other surface of the first housing, and the second direction is a direction directed from the other surface toward one surface of the second housing.

7. The refrigerant manifold of claim 1, wherein the plurality of component mounting parts comprise:
a heat exchanger mounting part on which a heat exchanger is mounted;
a valve mounting part on which a valve is mounted; and
a sensor mounting part on which a sensor is mounted, and
wherein all the heat exchanger mounting part, the valve mounting part, and the sensor mounting part are formed in the same direction.

8. The refrigerant manifold of claim 1, wherein a component insertion hole, into which a component is inserted, is formed in the plurality of component mounting parts and formed in a direction parallel to a first direction.

9. The refrigerant manifold of claim 1, wherein a fastening hole, into which a fastening member or a component is inserted and fastened, is formed in the plurality of component mounting parts and formed in a direction parallel to a first direction.

10. The refrigerant manifold of claim 1, wherein a flange insertion hole, into which a communication portion protruding from a flange is inserted, is formed in the plurality of flange mounting parts and formed in a direction parallel to a second direction.

11. The refrigerant manifold of claim 1, wherein a flange fastening hole, into which a fastening member is inserted and fastened, is formed in the plurality of flange mounting parts and formed in a direction parallel to a second direction.

12. The refrigerant manifold of claim 1, wherein the plurality of component mounting parts are formed in a first direction, and the flange mounting part is formed in a third direction intersecting the first direction.

13. The refrigerant manifold of claim 12, wherein the first direction is a direction directed from one surface toward the other surface of the first housing, and the third direction is a direction perpendicular to the first direction.

14. The refrigerant manifold of claim 13, wherein the plurality of flange mounting parts is disposed at an upper side of the second housing and formed in an upward direction.

15. The refrigerant manifold of claim 12, wherein a plurality of flange mounting parts are further formed on the other surface of the first housing, and the plurality of flange mounting parts of the first housing are formed in the third direction.

16. The refrigerant manifold of claim 8, wherein the component insertion hole communicates with the first refrigerant channel of the first housing.

17. The refrigerant manifold of claim 10, wherein the flange insertion hole communicates with the second refrigerant channel of the second housing.

18. The refrigerant manifold of claim 7, wherein the heat exchanger mounting part is provided as a plurality of heat exchanger mounting parts, and any one of the heat exchangers mounted on the plurality of heat exchanger mounting parts comprises a water-cooled condenser.

19. The refrigerant manifold of claim 1, wherein some of the plurality of flange mounting parts are formed on the first housing, and the remaining flange mounting parts are formed on the second housing.
